(19) United States
(12) Patent Application Publication
(10) Pub. No.: US 2017/0218914 A1
(43) Pub. Date: Aug. 3, 2017

(54) Barton Float Generator

(71) Applicant: Antonio jacob Barton, Warren, MI (US)

(72) Inventor: Antonio jacob Barton, Warren, MI (US)

(21) Appl. No.: 15/014,030

(22) Filed: Feb. 3, 2016

(51) Int. Cl. F03B 13/20

(52) U.S. Cl. CPC F03B 13/20

(57) ABSTRACT

The Barton Float Generator is a device that uses water currents, water waves or water elevation changes to push/pull magnets threw electrical coils to generate electrical energy.

### BACKGROUND

Field of Invention

The Bartons Float Generator is a device which is generated toward the art of generating alternative energy using water currents, water waves or water elevation changes.

Description of related art

Currently the state of this art is there are very few devices devoted to the art of alternative energy that are efficient, effective and practical.

### BRIEF SUMMARY OF INVENTION

The purpose of the Bartons Float Generator is to provide alternative energy that is effective, efficient and practical. Unlike other devices that generate electrical power from water currents, water waves or water elevation changes, The Barton Float Generator uses multiple linear motions to generate electrical energy. Other devices that use these methods, only generate an electrical charge when a particular motion is generated. For example, these devices rely on an elevation rise or a wave to positively change the elevation of the device to generate an electrical charge; if there is a negative elevation change in the water the device does nothing. This makes them ineffective and not versatile, where the Barton Float Generator can generate an electrical charge in a positive or negative change. The Barton Float Generator does not use motors, gears or dangerous chemicals making the Barton Float Generator cleaner safer and more cost effective while maintaining efficiency and practicality. The Barton Float Generator consists of a float which will move up or down in relation to the water current, water waves or changes in water elevation. This float will then move a magnetic field to generate electric energy through Faraday's Law of Induction.

### DESCRIPTION OF DRAWINGS

In FIG. 1, each individual part is are drawn in two dimension and is labeled. The float, 1, will be the object that will rest upon the body of water and will raise up when in contact with a wave or a change in water elevation. The plastic pole, 2, will be driven into the middle of the float and will be attached to the float. Next is a total of eight magnets, 3, they are attached to the plastic pole in groups of four. The hollow tube, 4, which the magnets will feed into and finally is four electrical coils, 5, that will wrap around the tubes (4).

In FIG. 2, the parts are drawn in three dimensional to show, how The Barton Float Generator will be assembled. The float (1) is the center of the device. The plastic pole (2), is once again driven in the middle and attached to the float (1). Once driven threw the float, the eight magnets (3), will be attached in a group of four to the plastic pole (2). Then the eight magnets will be fed into the plastic tubes (4). The four electric coils (5), will be wrapped around the two tubes (4). Once this is done the complete assembly is now complete and the Barton Float Generator is now ready to be used.

In FIG. (3) we see The Bartons Float Generator in two dimensional illustration to show the reader another illustration of the assembly of The Barton Float Generator.

In FIG. 4, The Barton Float Generator is fully assembled with the eight magnet's (3) semi encased into the top and bottom tubes (4). FIG. 4 illustrates the Barton Float Generator in a rested state of a body of water.

FIG. 5 is what the Barton Float Generator will look like from both top and bottom view. The float (1) is not seen in this illustration because it will be covered by the four electric coils (4).

In FIG. 6 this shows the action of The Barton Float Generator. As The wave approaches the float raises up. As the float raises up, the plastic pole (2) goes with it. The eight attached magnets (3), pass thru the top and bottom tubes (5). The magnetic force from the magnets is then passed through the four electrical coils (4), and an electrical charge is generated.

FIG. 7 illustrates a continuation of FIG. 6, in this illustration the wave has almost passed The Barton Float Generator and the Float (1) is lowered. The plastic pole (2) follows the Float (1). The eight magnets are lowered through the top and bottom tube (5). Even though the magnets are lowered to the resting position (2), the magnetic force is then passed through the four electrical coils and electrical charge is generated once again.

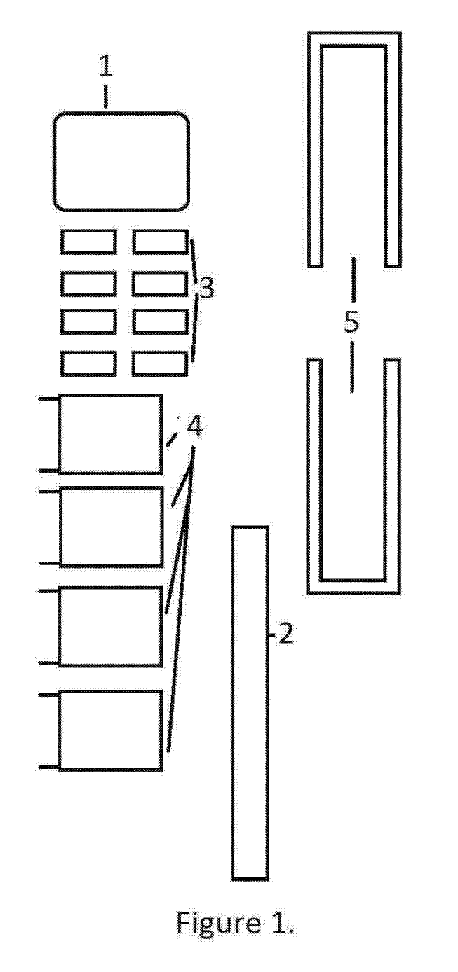

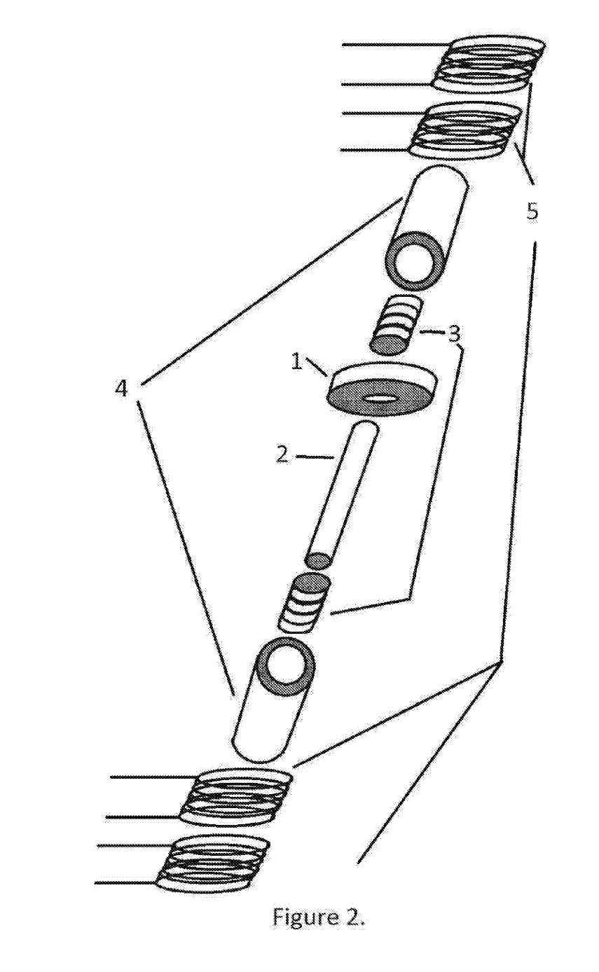

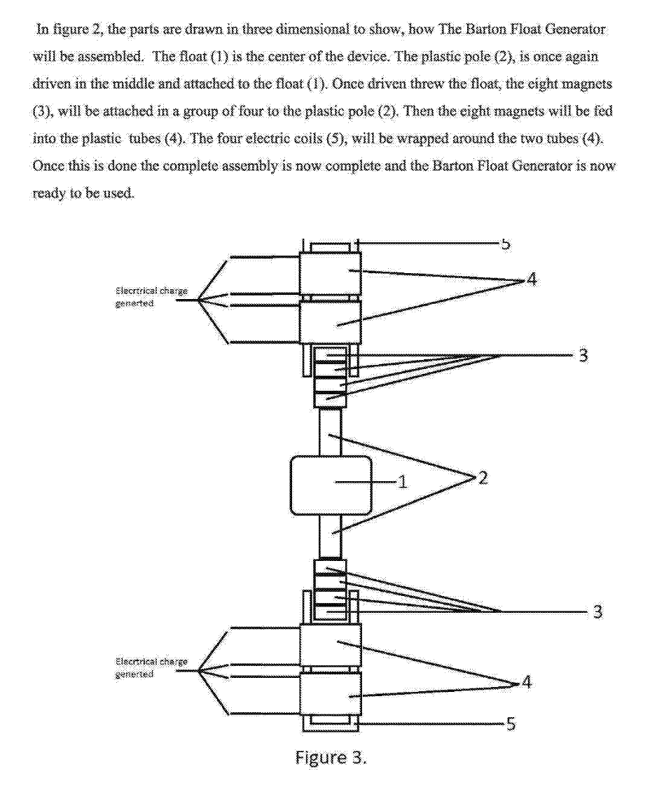

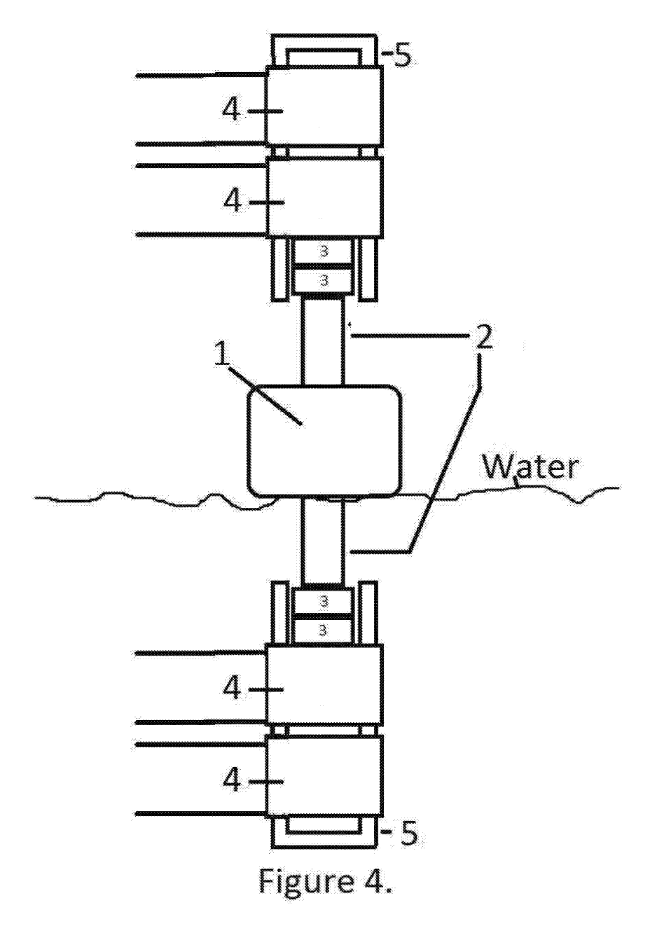

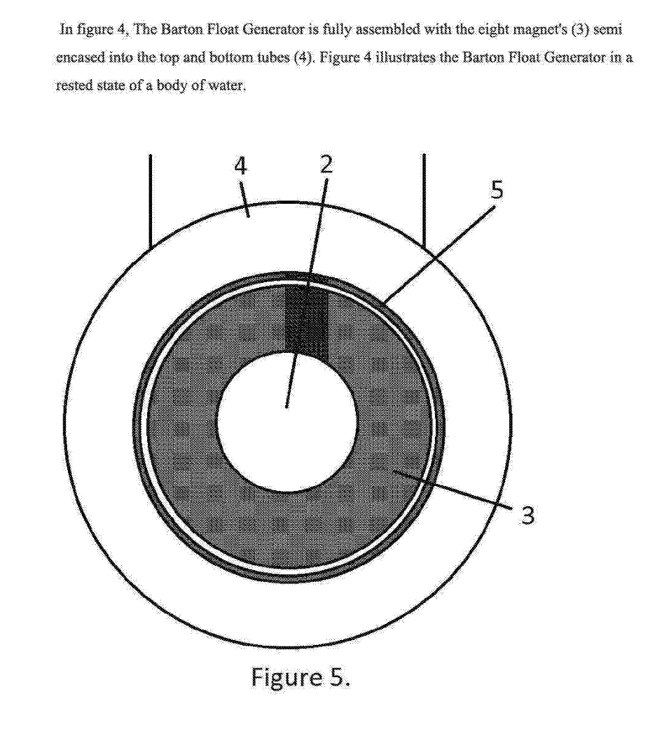

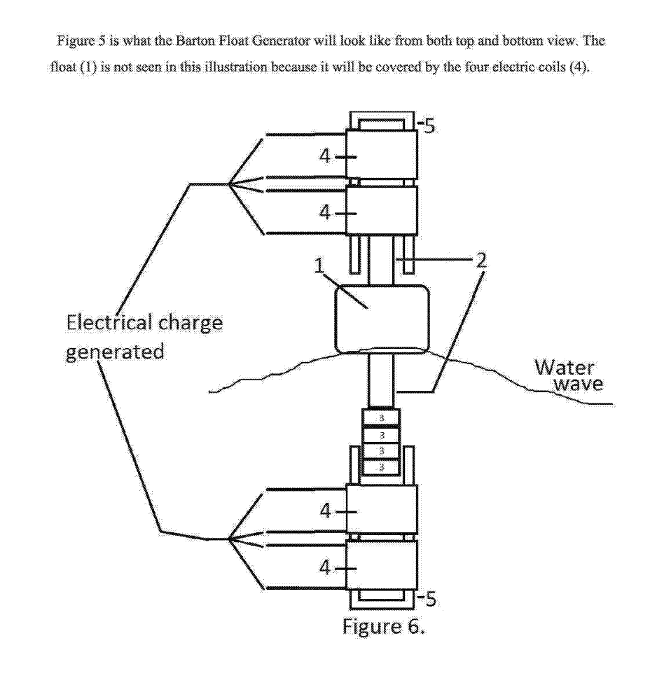

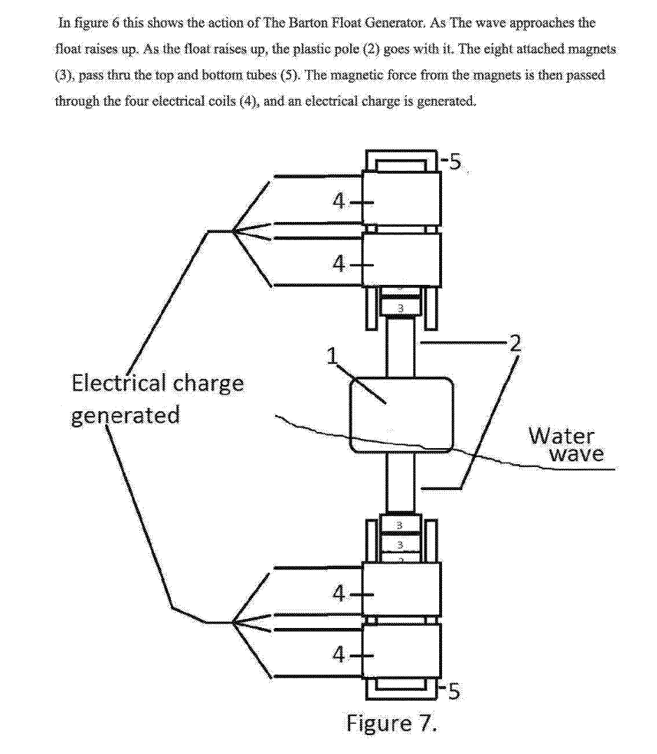

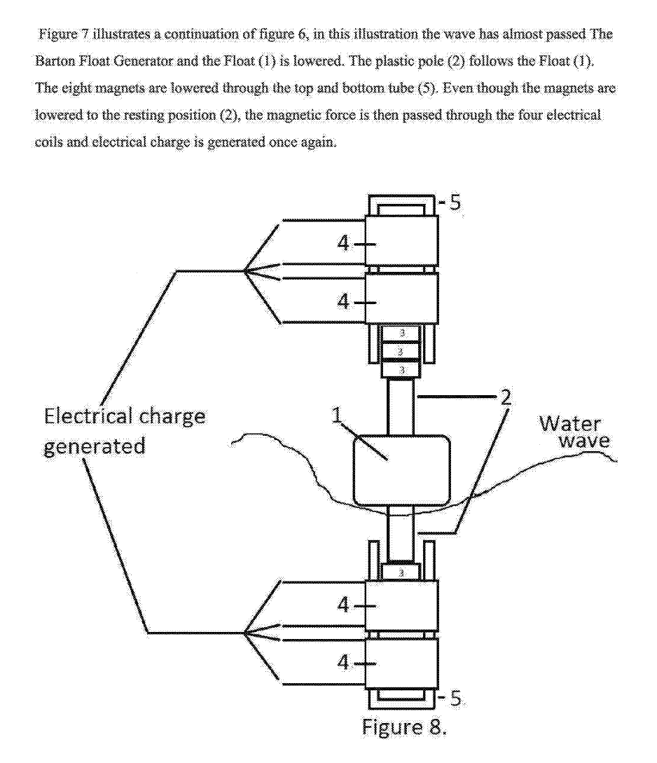

In FIG. 8, The Barton Float Generator reacts to a negative water elevation compared to the normal resting state described in FIG. 2. The Float descends with the water, the plastic pole follows. The magnets descends and the magnetic force once again passes through the electrical coils, generating Electrical energy.

1. The barton Float Generator is a device that uses water currents, water waves or water elevation changes to push and pull a magnetic field.

2. the barton Float Generator is made of a float, plastic pole, magnets, tubes and electrical coils.

3. the Barton Float Generator is a device which uses the kinetic energy in any current of water to change it into electrical energy.
